(19) United States
(12) Patent Application Publication
(10) Pub. No.: US 2024/0205832 A1
(43) Pub. Date: Jun. 20, 2024

(54) METOD AND DEVICE FOR PROCESSING DATA, AND USER EQUIPMENT

(71) Applicant: SPREADTRUM COMMUNICATIONS (SHANGHAI) CO., LTD., Shanghai (CN)

(72) Inventors: Huayu ZHOU, Shanghai (CN); Miao WANG, Shanghai (CN); Zhenzhu LEI, Shanghai (CN); Zhengang PAN, Shanghai (CN)

(21) Appl. No.: 18/553,574

(22) PCT Filed: Apr. 1, 2022
(86) PCT No.: PCT/CN2022/084852

§ 371 Date: Oct. 2, 2023

(30) Foreign Application Priority Data
Apr. 6, 2021 (CN) 202110368440.2

(51) Int. Cl. H04W 52/02

(52) U.S. Cl. CPC H04W 52/0245

(57) ABSTRACT

A method for processing data, a device for processing data, and a user equipment (UE) are provided. The method for processing data includes: determining validity of a timing advance (TA) during small data transmission; and in response to a determination that the TA is invalid, terminating the small data transmission or obtaining the TA again.

### TECHNICAL FIELD

The present disclosure relates to the field of communications, and in particular, to a method for processing data, a device for processing data, and a user equipment (UE).

### BACKGROUND

When machine type communication (MTC) or the Internet of Things (IOT) is widely used, small data transmission (SDT) is an efficient transmission method. When a data volume is small, a user equipment (UE) can transmit and receive data in an inactive or idle state, without entering a connected state. This can avoid frequent massive establishment and release of radio resource control (RRC) connections, thereby reducing a power consumption of the UE.

Specifically, the UE may send data (such as a message 3) in a random access channel (RACH) procedure. The UE may also send data in a configured grant (CG) based uplink transmission, and then perform subsequent transmission, retransmission, or reception. A multiple-beams operation has been introduced in 5G. When the UE transmits and receives data in the inactive or idle state, multiple beams also need to be considered.

In a communication system using multiple beams, how to improve data transmission quality of the SDT and reduce the power consumption of the UE is a problem to be addressed.

### SUMMARY

The present disclosure provides a method for processing data, a device for processing data, and a UE, to improve data transmission quality of SDT and reduce power consumption of the UE.

In a first aspect, the present disclosure provides a method for processing data, including: determining validity of a timing advance (TA).

The method determines the validity of the TA during the SDT. In response to a determination that the TA is valid, the SDT continues. In response to a determination that the TA is invalid, the SDT is terminated, thereby improving the quality of the SDT, and avoiding additional power consumption of the UE due to the data transmission failure.

In one or more embodiments, the determining the validity of the TA includes: in response to a determination that a change in reference signal received power (RSRP) of a serving synchronization signal block (SSB) exceeds a first threshold, determining that the TA is invalid; and in response to a determination that the change in the RSRP of the serving SSB does not exceed the first threshold, determining that the TA is valid.

In one or more embodiments, the determining the validity of the TA includes: in response to a determination that a change in a first measurement value of a serving SSB exceeds a second threshold, determining that the TA is invalid; and in response to a determination that the change in the first measurement value of the serving SSB does not exceed the second threshold, determining that the TA is valid.

In one or more embodiments, the determining the validity of the TA includes: in response to a determination that a first measurement value of a serving SSB exceeds a third threshold, determining that the TA is invalid; and in response to a determination that the first measurement value of the serving SSB does not exceed the third threshold, determining that the TA is valid.

In one or more embodiments, the determining the validity of the TA includes: in response to a determination that a change in RSRP of a serving SSB exceeds a fourth threshold, and a change in RSRP of at least one of SSBs included in a first set exceeds a fifth threshold, determining that the TA is invalid; otherwise, determining that the TA is valid.

In one or more embodiments, the fourth threshold is equal to the fifth threshold.

In one or more embodiments, the SSBs in the first set are M strongest SSBs, and M is greater than or equal to 1.

In one or more embodiments, said determining the validity of the TA includes: in response to a determination that a change in RSRP of a serving SSB exceeds a sixth threshold and RSRP of at least one of SSBs included in a second set exceeds a seventh threshold, determining that the TA is invalid; otherwise, determining that the TA is valid.

In one or more embodiments, the sixth threshold is equal to the seventh threshold.

In one or more embodiments, the SSBs included in the second set are K strongest SSBs, and K is greater than or equal to 1.

In one or more embodiments, the determining the validity of the TA includes: in response to a determination that a change in RSRP of at least one of SSBs included in a third set exceeds an eighth threshold, determining that the TA is invalid; and in response to a determination that a change of RSRP of any one of N strongest SSBs does not exceed the eighth threshold, determining that the TA is valid.

In one or more embodiments, the SSBs included in the third set are the N Strongest SSBs, and N is greater than or equal to 1.

In one or more embodiments, the first measurement value includes: a user equipment (UE) Rx-Tx time difference, a downlink angle of arrival (DL AoA), or a downlink reference signal time difference (DL RSTD).

In one or more embodiments, the serving SSB is an SSB indicated in higher-layer signaling.

In one or more embodiments, the higher-layer signaling is a sounding reference signal (SRS) configuration signaling.

In one or more embodiments, the serving SSB is an SSB associated with a resource used by a UE for uplink configured-grant (CG) transmission.

In one or more embodiments, the SSB associated with the resource used by the UE for the uplink CG transmission is obtained based on an association relationship between the resource for the uplink CG transmission and the SSB.

In one or more embodiments, the association relationship between the resource for the uplink CG transmission and the SSB is derived based on an association relationship between the resource for the uplink CG transmission and a random access occasion (RO) or RACH occasion (RO); or the association relationship between the resource for the uplink CG transmission and the SSB is derived based on an association relationship between the resource for the uplink CG transmission and a random access preamble.

In a second aspect, the present disclosure provides a device for processing data, including a determining unit configured to determine validity of a TA.

In a third aspect, the present disclosure provides a chip module, including the device for processing data according to the second aspect.

In a fourth aspect, the present disclosure provides a UE, including: at least one processor, a memory, and at least one computer program. The at least one computer program is stored in the memory and includes instructions. The instructions are executed by the UE to perform the method according to any one of the first aspect.

In a fifth aspect, the present disclosure provides a computer-readable storage medium. The computer-readable storage medium stores a computer program, and when the computer program is executed by a computer, the computer performs the method according to any one of the first aspect.

In a sixth aspect, the present disclosure provides a computer program. The computer program is executed by a processor to perform the method according to any one of the first aspect.

In one or more embodiments, the computer program according to the sixth aspect may be entirely or partially stored in a storage medium packaged together with the processor, or may be entirely or partially stored in a memory not packaged together with a processor.

In a seventh aspect, the present disclosure provides a computer program product. The computer program product includes a computer program, and the computer program is executed by a computer to perform the method according to any one of the first aspect.

### BRIEF DESCRIPTION OF DRAWINGS

To describe the technical solutions in the embodiments of the present disclosure more clearly, the following briefly describes the accompanying drawings required to be used in the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a flowchart of a method for processing data according to an embodiment of the present disclosure;

FIG. 2 is a flowchart of a method for processing data according to another embodiment of the present disclosure;

FIG. 3 is a structural diagram of a device for processing data according to an embodiment of the present disclosure; and

FIG. 4 is a structural diagram of a device for processing data according to another embodiment of the present disclosure.

### DESCRIPTION OF EMBODIMENTS

The terms used in embodiments of the present disclosure are used only to explain the specific embodiments of the present disclosure, and are not intended to limit the present disclosure.

In a 5G communication system, a synchronization signal and a broadcast channel are sent in a form of a synchronization signal block (SSB), and a function of beam sweeping is introduced. A primary synchronization signal (PSS), a secondary synchronization signal (SSS), and a physical broadcast channel (PBCH) are located in the SSB (SS/PBCH block). Each SSB can be regarded as a resource for one beam (analog domain) in a beam sweeping process. A plurality of SSBs form a synchronization signal burst (SS burst). The SS burst can be regarded as relatively concentrated resources containing a plurality of beams. A plurality of SS bursts form an SS burst set. The SSB is repeatedly sent on different beams, which is one beam scanning process. Through beam sweeping training, a UE can perceive on which beam the received signal is strongest.

SDT is an efficient transmission method. When a data volume is small, the UE can send and receive data in an inactive or idle state without entering a connected state. This can avoid frequent establishment and release of massive RRC connections, thereby reducing a power consumption of the UE. Specifically, the UE can send data (such as a message 3) in a RACH procedure. The UE can also send data during uplink CG transmission. A multi-beam operation has been introduced in 5G. When the UE performs the SDT in the inactive or idle state, multiple beams also need to be considered.

In a communication system using the multiple beams, how to improve data transmission quality of the SDT and reduce the power consumption of the UE is a problem to be addressed.

Therefore, the present disclosure provides a method for processing data, a device for processing data, and a UE, to improve the data transmission quality of the SDT and reduce the power consumption of the UE.

The present disclosure can be applied to communication systems that use the multi-beam operation, such as 5G, MTC, and IT. The UE described in the present disclosure may include, but is not limited to, a handheld device with a wireless communication function, a vehicle-mounted device, a wearable device, and the like. A network-side device described in the present disclosure may be a base station. In different communication systems, types of the base station may be different, which is not limited in the present disclosure.

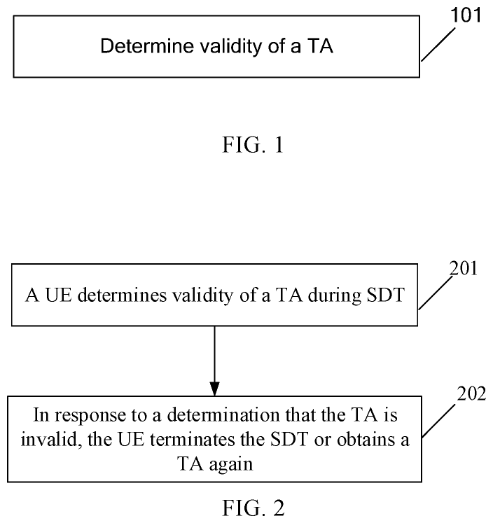

FIG. 1 is a flowchart of a method for processing data according to an embodiment of the present disclosure. As shown in FIG. 1, the method may include following steps.

In step 101, validity of a timing advance (TA) is determined.

TA is generally a time advance of uplink timing of sending uplink data by a UE compared with corresponding downlink timing of receiving downlink data. A specific value of the TA can be calculated by a network-side device based on a random access preamble sent by the UE, and notified to the UE through a timing advance command (TAC).

During data transmission, as the UE moves, a distance between the UE and the network-side device may change. Correspondingly, the time advance of the uplink timing of sending the uplink data by the UE compared with the corresponding downlink timing of receiving the downlink data also changes. If the change reaches a certain level, the TA used during SDT cannot match an actually required time advance. This may cause a data transmission failure during the SDT, increase a power consumption of the UE, and cause interference to data transmission of another UE. Therefore, in this step, the validity of the TA used for the SDT is determined. In response to a determination that the TA is valid, the SDT between the UE and the network-side device is maintained. In response to a determination that the TA is invalid, the TA is obtained again or the SDT is terminated, thereby avoiding additional power consumption of the UE due to the data transmission failure and reducing the interference to the another UE.

The following describes methods for determining the validity of the TA in a multi-beam scenario.

In a first method, this step may be implemented as follows.

In response to a determination that a change in reference signal received power (RSRP) of a serving SSB exceeds a first threshold, it is determined that the TA is invalid.

In response to a determination that the change in the RSRP of the serving SSB does not exceed the first threshold, it is determined that the TA is valid.

The serving SSB may be an SSB configured by the network-side device for the UE, or may be an SSB independently selected by the UE.

The serving SSB may be configured by the network-side device for the UE. In this case, the network-side device may configure the serving SSB for the UE based on channel state information of the UE and a situation of a cell (such as traffic load of each beam). The network-side device may obtain the channel state information in a data transmission and reception process. Then, the network-side device may indicate the SSB configured for the UE to the UE through higher-layer signaling. The higher-layer signaling may be sounding reference signal (SRS) configuration signaling. The SRS configuration signaling may be SRS-SpatialRelationInfo signaling, RRC Release signaling, or the like. For example, the serving SSB may be indicated by a parameter ssb-Index in the SRS-SpatialRelationInfo signaling.

During SDT based on uplink CG transmission, the serving SSB may be independently selected by the UE. In this case, the serving SSB may be an SSB associated with a resource used by the UE for the uplink CG transmission. Based on an association relationship between the resource for the uplink CG transmission and the SSB, the UE can determine the SSB associated with the resource used by the UE for the uplink CG transmission. The association relationship between the resource for the uplink CG transmission and the SSB may be derived based on an association relationship between the resource for the uplink CG transmission and a random access occasion (RO) or RACH occasion (RO), or the association relationship between the resource for the uplink CG transmission and the SSB may be derived based on an association relationship between the resource for the uplink CG transmission and a random access preamble. The UE may independently select the serving SSB, which can reduce an overhead of control signaling of the network-side device.

When the UE moves, the RSRP of the serving SSB generally changes. Whether there is a significant change in the distance between the UE and the network-side device can be determined by determining whether the change in the RSRP of the serving SSB exceeds the first threshold, and thus whether the TA is valid is determined. A value of the first threshold is not limited in the present disclosure.

The change in the RSRP may be a difference between RSRP of the serving SSB at a current time point and RSRP of the serving SSB at a first time point. The first time point is a time point before the current time point, and a time difference between the first time point and the current time point is not limited in the present disclosure.

In a second method, this step may be implemented as follows.

In response to a determination that a change in a first measurement value of a serving SSB exceeds a second threshold, it is determined that the TA is invalid.

In response to a determination that the change in the first measurement value of the serving SSB does not exceed the second threshold, it is determined that the TA is valid.

In a third method, this step may be implemented as follows.

In response to a determination that a first measurement value of a serving SSB exceeds a third threshold, it is determined that the TA is invalid.

In response to a determination that the first measurement value of the serving SSB does not exceed the third threshold, it is determined that the TA is valid.

For the second and third methods, the first measurement value may include: a UE Rx-Tx time difference, a downlink angle of arrival (DL AoA), or a downlink reference signal time difference (DL RSTD).

In the multi-beam scenario, due to a narrow beam, even if the RSRP of the serving SSB changes slightly, the distance between the UE and the network-side device may change significantly. This makes it difficult for the UE to determine the validity of the TA simply based on the change in the RSRP of the serving SSB. Specifically, within one narrow beam, the UE may move both from a far end to a near end and from a main lobe of the one beam to a side lobe of the one beam. In this case, since the distance between the UE and the network-side device becomes smaller, the TA may already be significantly different from an actually required TA. However, since affecting of the smaller distance and affecting of the side lobe of the beam cancel each other, the RSRP of the serving SSB does not change significantly. Therefore, the present disclosure provides the above second and third methods to determine the validity of the TA based on the first measurement value or the change in the first measurement value rather than the RSRP of the serving SSB.

In an embodiment, for one narrow beam under one transmission/reception point (TRP), the first measurement value may be the UE Rx-Tx time difference or the DL AoA. For a plurality of narrow beams under a plurality of TRPs, the first measurement value may be the DL RSTD.

The UE Rx-Tx time difference may be T_{UE-RX}−T_{UE-TX}. T_{UE-RX} represents a time point at which the UE receives a downlink subframe #i from a transmission point (TP), and T_{UE-TX} represents a time point at which the UE sends an uplink subframe j. The uplink subframe j is an uplink subframe closest to the downlink subframe i in time.

The DL RSTD may be a relative time difference between a TP j and a reference TP i. The DL RSTD is equal to T_{SubframeRxj}−T_{SubframeRxi}. T_{SubframeRxj} represents an initial time point at which the UE receives a subframe from the TP j, and T_{subframeRxi} represents an initial time point at which the UE receives a subframe from the TP i, which is closest in time to the subframe received from the TP j.

In a fourth method, this step may be implemented as follows.

In response to a determination that a change in RSRP of a serving SSB exceeds a fourth threshold and a change in RSRP of at least one of SSBs included in a first set exceeds a fifth threshold, it is determined that the TA is invalid; otherwise, it is determined that the TA is valid.

The first set may include M strongest SSBs, and M is greater than or equal to 1.

In some embodiments, to prevent the M strongest SSBs from including the serving SSB, the M strongest SSBs may be M strongest SSBs other than the serving SSB.

Since the third threshold and the fourth threshold both involve the change in the RSRP, the third threshold and the fourth threshold may be the same. The M strongest SSBs may correspond to a same fifth threshold or different fifth thresholds. In order to reduce data processing complexity of the UE and improve a data processing speed, the same fifth threshold is preferred.

In a fifth method, this step may be implemented as follows.

In response to a determination that a change in RSRP of a serving SSB exceeds a sixth threshold and RSRP of at least one of SSBs included in a second set exceeds a seventh threshold, it is determined that the TA is invalid; otherwise, it is determined that the TA is valid. The second set may include K strongest SSBs, and K is greater than or equal to 1.

In some embodiments, to prevent the K strongest SSBs from including the serving SSB, the K strongest SSBs may be K strongest SSBs other than the serving SSB.

In order to reduce a signaling overhead, in some scenarios, the fifth threshold and the sixth threshold may be the same (only one value needs to be configured). The K strongest SSBs may correspond to a same seventh threshold or different seventh thresholds. In order to reduce data processing complexity of the UE and improve a data processing speed, the same seventh threshold is preferred.

In one narrow beam, the UE may move both from a far end of the network-side device to a near end of the network-side device and from a main lobe of the one beam to a side lobe of the one beam. In this case, RSRP on a beam adjacent to the side lobe of the current beam or a change in the RSRP increases significantly. Therefore, on a basis of the change in the RSRP of the serving SSB, the validity of the TA can also be determined based on the RSRP on the adjacent beam or the change in the RSRP. Therefore, this step can be achieved through the fourth or fifth implementation.

In a sixth method, this step may be implemented as follows.

In response to a determination that a change in RSRP of at least one of SSBs included in a third set exceeds an eighth threshold, it is determined that the TA is invalid; and in response to a determination that a change of RSRP of any one of N strongest SSBs does not exceed the eighth threshold, it is determined that the TA is valid.

The third set may include N strongest SSBs. N is greater than or equal to 1.

The N strongest SSBs may correspond to a same eighth threshold or different eighth thresholds. In order to reduce data processing complexity of the UE and improve a data processing speed, the same eighth threshold is preferred.

The UE moves between a plurality of beams, and the plurality of beams come from a same TRP. A distance between the UE and the TRP does not significantly change during the movement. In response to a determination that a change in RSRP of any one of the plurality of beams does not exceed a threshold, it can be determined that the TA is valid. In response to a determination that a change in RSRP of at least one of the plurality of beams exceeds the threshold, it can be determined that the TA is invalid. Therefore, this step can be achieved through the fourth method, the fifth method, or the sixth method.

It should be noted that two or more of the first to sixth methods may be combined in a practical application to obtain more embodiments. For example, the first method and the second method may be combined. In response to a determination that the change in the RSRP of the serving SSB exceeds the first threshold, or the change in the first measurement value of the serving SSB exceeds the second threshold, it is determined that the TA is invalid; otherwise, it is determined that the TA is valid. For another example, the fourth method and the fifth method may be combined. In response to a determination that the change in the RSRP of the serving SSB exceeds the fourth threshold and the change in the RSRP of at least one of the M strongest SSBs exceeds the fifth threshold, or in response to a determination that the change in the RSRP of the serving SSB exceeds the fourth threshold and the RSRP of at least one of the M strongest SSBs exceeds the seventh threshold, it is determined that the TA is invalid; otherwise, it is determined that the TA is valid. Other possible combinations are not described herein.

Specific values of the thresholds involved in the above embodiments are not limited in embodiments of the present disclosure. The thresholds may be the same or different, which is not limited in the embodiments of the present disclosure.

The strongest SSB in the above embodiments may be the SSB strongest RSRP, the SSB with strongest SINR, or the like. A specific measurement value used to determine the strongest SSB is not limited in the embodiments of the present disclosure.

Before the SDT, the UE needs to determine a serving SSB of the SDT. During the SDT, the UE can re-determine a serving SSB for the SDT, and switch the serving SSB to the re-determined serving SSB, for example, switch the serving SSB from a SSB1 to a SSB2. The following describes a method for determining a serving SSB of SDT for a UE.

The serving SSB may be configured by a network-side device for the UE. In this case, the network-side device may configure the serving SSB for the UE based on channel state information of the UE and a situation of a cell (such as business load of each beam). The network-side device may obtain for the channel state information of the UE in a data transmission and reception process. Then, the network-side device may indicate the SSB configured for the UE to the UE by higher-layer signaling. The higher-layer signaling may be SRS configuration signaling. The SRS configuration signaling may be SRS-SpatialRelationInfo signaling, RRC Release signaling, or the like. For example, the serving SSB may be indicated by a parameter ssb-Index in the SRS-SpatialRelationInfo signaling.

During SDT based on uplink CG transmission, the serving SSB may be independently selected by the UE. In this case, the serving SSB may be an SSB associated with a resource used by the UE for the uplink CG transmission. Based on an association relationship between the resource for the uplink CG transmission and the SSB, the UE can determine the SSB associated with the resource used by the UE for the uplink CG transmission. The association relationship between the resource for the uplink CG transmission and the SSB may be derived based on an association relationship between the resource for the uplink CG transmission and an RO; or the association relationship between the resource for the uplink CG transmission and the SSB may be derived based on an association relationship between the resource for the uplink CG transmission and a random access preamble. When the UE independently selects the serving SSB, an overhead of control signaling of the network-side device is reduced.

FIG. 2 is a flowchart of a method for processing data according to another embodiment of the present disclosure. As shown in FIG. 2, the method may include following steps.

In step 201, a UE determines validity of a TA during SDT.

In step 202, in response to a determination that the TA is invalid, the UE terminates the SDT or obtains the TA gain.

For implementation of the steps 201 and 202, reference may be made to the corresponding description in FIG. 1. Details are not described herein again.

The method determines, during the SDT, the validity of the TA used for the SDT. If the TA is invalid, the SDT is terminated and the TA is obtained again to avoid a data transmission failure caused by invalidity of the TA. This avoids an additional power consumption of the UE due to the data transmission failure, and can also reduce interference to data transmission of another UE because the UE uses the invalid TA for data transmission.

It can be understood that some or all of the steps or operations in the above embodiments are only examples, and other operations or variants of various operations can further be performed in the embodiments of the present disclosure. In addition, the steps may be performed in different orders presented in the foregoing embodiments, and not all the operations in the foregoing embodiments need to be performed.

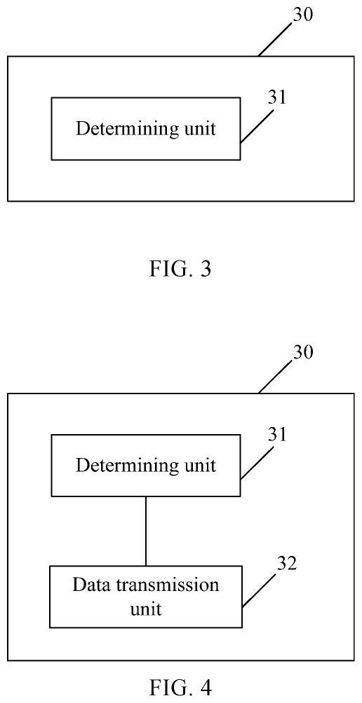

FIG. 3 is a structural diagram of a data processing device according to an embodiment of the present disclosure. As shown in FIG. 3, the device 30 may include:
a determining unit 31 configured to determine validity of a TA.

Optionally, as shown in FIG. 4, the device 30 may further include:
a data transmission unit 32 configured to perform SDT, and terminate the SDT if the determining unit 31 determines that the TA is invalid.

Optionally, the determining unit 31 is specifically configured to:
when a change in RSRP of a serving SSB exceeds a first threshold, determine that the TA is invalid; and
when the change in the RSRP of the serving SSB does not exceed the first threshold, determine that the TA is valid.

Optionally, the determining unit 31 is specifically configured to:
when a change in a first measurement value of a serving SSB exceeds a second threshold, determine that the TA is invalid; and
when the change in the first measurement value of the serving SSB does not exceed the second threshold, determine that the TA is valid.

Optionally, the determining unit 31 is specifically configured to:
when a first measurement value of a serving SSB exceeds a third threshold, determine that the TA is invalid: and
when the first measurement value of the serving SSB does not exceed the third threshold, determine that the TA is valid.

Optionally, the determining unit 31 is specifically configured to:
when a change in RSRP of a serving SSB exceeds a fourth threshold, and a change in RSRP of at least one of SSBs included in a first set exceeds a fifth threshold, determine that the TA is invalid; otherwise, determine that the TA is valid.

Optionally, the fourth threshold is equal to the fifth threshold.

Optionally, the SSBs included in the first set are M strongest SSBs, and M is greater than or equal to 1.

Optionally, the determining unit 31 is specifically configured to:
when a change in RSRP of a serving SSB exceeds a sixth threshold, and RSRP of at least one of SSBs included in a second set exceeds a seventh threshold, determine that the TA is invalid; otherwise, determine that the TA is valid.

Optionally, the sixth threshold is equal to the seventh threshold.

Optionally, the SSBs included in the second set are K strongest SSBs, and K is greater than or equal to 1.

Optionally, the determining unit 31 is specifically configured to:
when a change in RSRP of at least one of SSBs included in a third set exceeds an eighth threshold, determine that the TA is invalid; and when a change of RSRP of each of N strongest SSBs does not exceed the eighth threshold, determine that the TA is valid.

Optionally, the SSBs included in the third set are N strongest SSBs, and N is greater than or equal to 1.

Optionally, the first measurement value includes: a UE Rx-Tx time difference, or a DL AoA, or a DL RSTD.

Optionally, the serving SSB is an SSB indicated in higher-layer signaling.

Optionally, the higher-layer signaling is SRS configuration signaling.

Optionally, the serving SSB is an SSB associated with a resource used by the UE for uplink CG transmission.

Optionally, the SSB associated with the resource used by the UE for the uplink CG transmission is obtained based on an association relationship between the resource for the uplink CG transmission and the SSB.

Optionally, the association relationship between the resource for the uplink CG transmission and the SSB is derived based on an association relationship between the resource for the uplink CG transmission and an RO; or the association relationship between the resource for the uplink CG transmission and the SSB is derived based on an association relationship between the resource for the uplink CG transmission and a random access preamble.

The devices 30 provided in the embodiments shown in FIG. 3 and FIG. 4 can be configured to execute the technical solutions of the method embodiments shown in FIG. 1 and FIG. 2. For an implementation principle and a technical effect of the device 30, reference may be further made to the related description of the method embodiments.

It should be understood that the unit division of the devices shown in FIG. 3 and FIG. 4 is merely logical function division. In actual implementation, the units may be fully or partially integrated into a physical entity, or may be physically separated These units may be all implemented in a form of software through processing element calling; may be all implemented in a form of hardware; or may be partially implemented in a form of software through processing element calling, and partially implemented in a form of hardware. For example, the data transmission unit may be a separate processing element or integrated into a chip of an electronic device. Other units are implemented in a similar way. In addition, these units may be fully or partially integrated, or implemented independently. For example, the foregoing data transmission device may be a chip or a chip module, or may be a part of a chip or a chip module. During the implementation, each step of the foregoing method or each of the foregoing units may be performed through an integrated logic circuit of hardware in a processing element or through an instruction in a form of software.

For example, the foregoing modules may be one or more integrated circuits configured to implement the foregoing methods, such as one or more application-specific integrated circuits (ASICs), one or more digital signal processors (DSPs), or one or more field-programmable gate arrays (FPGAs). For another example, these modules may be integrated and implemented in a form of a system-on-a-chip (SOC).

The present disclosure provides a UE, including a processor and a transceiver. The processor and the transceiver cooperate to implement the methods provided in the embodiments shown in FIG. 1 and FIG. 2 of the present disclosure.

The present disclosure further provides a UE, including a storage medium and a central processing unit (CPU). The storage medium may be a non-volatile storage medium, and stores a computer executable program. The CPU is connected to the non-volatile storage medium and executes the computer executable program to implement the methods provided in the embodiments shown in FIG. 1 and FIG. 2 of the present disclosure.

The embodiments of the present disclosure further provide a computer-readable storage medium. The computer-readable storage medium stores a computer program. The computer program is executed by a computer to perform the methods provided in the embodiments shown in FIG. 1 and FIG. 2 of the present disclosure.

The embodiments of the present disclosure further provide a computer program product. The computer program product includes a computer program. The computer program is executed by a computer to perform the methods provided in the embodiments shown in FIG. 1 and FIG. 2 of the present disclosure.

In the present application, the term “at least one” refers to one or more, and the term “multiple” refers to two or more. The term “and/or” describes associations between associated objects, and it indicates three types of relationships. For example, “A and/or B” may indicate that A alone, A and B, or B alone. “A” and “B” each may be singular or plural. The character “/” generally indicates that the associated objects are in an “or” relationship. The term “at least one of the followings” or a similar expression refers to any combination of these items, including any combination of single items or plural items. For example, at least one of a, b, and c may represent: a, b, c, a and b, a and c, b and c, or a, b, and c, where a, b, and c may be singular or plural.

Those of ordinary skill in the art may be aware that units and algorithm steps described in the embodiments of the present disclosure can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

A person skilled in the art can clearly understand that for convenience and brevity of description, reference may be made to corresponding processes in the foregoing method embodiments for specific working processes of the foregoing system, device, and units. Details are not described herein again.

In the embodiments provided in the present disclosure, if implemented in a form of a software functional unit and sold or used as a stand-alone product, any function may be stored in a computer-readable storage medium. Based on this understanding, the technical solution of the present disclosure essentially, or a part contributing to the prior art, or some of the technical solutions may be embodied in a form of a software product. The computer software product is stored on a storage medium, and includes several instructions to enable a computer device (which may be a personal computer, a server, a network device, or the like) to execute all or some steps of the methods according to the embodiments of the present disclosure. The foregoing storage medium includes: any medium that can store program code, such as a USB flash disk, a removable hard disk, a read-only memory (ROM), a random access memory (RAM), a magnetic disk, or an optical disc.

The above merely describes specific implementations of the present disclosure. Any person skilled in the art can easily conceive modifications or replacements within the technical scope of the present disclosure, and these modifications or replacements shall fall within the protection scope of the present disclosure. Therefore, the protection scope of the present disclosure should be subject to the protection scope of the claims.

What is claimed is:

1. A method for processing data, comprising: determining validity of a timing advance (TA).

2. The method according to claim 1, wherein the determining the validity of the TA comprises:
in response to a determination that a change in reference signal received power (RSRP) of a serving synchronization signal block (SSB) exceeds a first threshold, determining that the TA is invalid; and
in response to a determination that the change in the RSRP of the serving SSB does not exceed the first threshold, determining that the TA is valid.

3. The method according to claim 1, wherein the determining the validity of the TA comprises:
in response to a determination that a change in a first measurement value of a serving SSB exceeds a second threshold, determining that the TA is invalid; and
in response to a determination that the change in the first measurement value of the serving SSB does not exceed the second threshold, determining that the TA is valid.

4. The method according to claim 1, wherein the determining the validity of the TA comprises:
in response to a determination that a first measurement value of a serving SSB exceeds a third threshold, determining that the TA is invalid; and
in response to a determination that the first measurement value of the serving SSB does not exceed the third threshold, determining that the TA is valid.

5. The method according to claim 1, wherein the determining the validity of the TA comprises:
in response to a determination that a change in RSRP of a serving SSB exceeds a fourth threshold and a change in RSRP of at least one of SSBs in a first set exceeds a fifth threshold, determining that the TA is invalid; otherwise, determining that the TA is valid.

6. The method according to claim 5, wherein the fourth threshold is equal to the fifth threshold.

7. The method according to claim 5, wherein the SSBs in the first set are M strongest SSBs, and M is greater than or equal to 1.

8. The method according to claim 1, wherein the determining the validity of the TA comprises:
in response to a determination that a change in RSRP of a serving SSB exceeds a sixth threshold and RSRP of at least one of SSBs comprised in a second set exceeds a seventh threshold, determining that the TA is invalid; otherwise, determining that the TA is valid.

9. The method according to claim 8, wherein the sixth threshold is equal to the seventh threshold.

10. The method according to claim 8, wherein the SSBs in the second set are K strongest SSBs, and K is greater than or equal to 1.

11. The method according to claim 1, wherein the determining the validity of the TA comprises:
in response to a determination that a change in RSRP of at least one of SSBs in a third set exceeds an eighth threshold, determining that the TA is invalid; and in response to a determination that a change of RSRP of any one of N strongest SSBs does not exceed the eighth threshold, determining that the TA is valid.

12. The method according to claim 11, wherein the SSBs in the third set are the N strongest SSBs, and N is greater than or equal to 1.

13. The method according to claim 3, wherein the first measurement value comprises: a user equipment (UE) Rx-Tx time difference, a downlink angle of arrival (DL AoA), or a downlink reference signal time difference (DL RSTD).

14. The method according to claim 2, wherein the serving SSB is an SSB indicated in higher-layer signaling.

15. (canceled)

16. The method according to claim 2, wherein the serving SSB is an SSB associated with a resource used by a UE for uplink configured-grant (CG) transmission.

17. The method according to claim 16, wherein the SSB associated with the resource used by the UE for the uplink CG transmission is obtained based on an association relationship between the resource for the uplink CG transmission and the SSB.

18. The method according to claim 17, wherein the association relationship between the resource for the uplink CG transmission and the SSB is derived based on an association relationship between the resource for the uplink CG transmission and a random access occasion (RO) or RACH occasion (RO); or the association relationship between the resource for the uplink CG transmission and the SSB is derived based on an association relationship between the resource for the uplink CG transmission and a random access preamble.

19-20. (canceled)

21. A UE, comprising:
at least one processor;
a memory; and
at least one computer program,
wherein the at least one computer program is stored in the memory and comprises instructions, and when being executed by the UE, the instructions cause the UE to: determine validity of a TA.

22. A non-transitory computer-readable storage medium, wherein the computer-readable storage medium stores a computer program, and when being executed by a computer, the computer program causes the computer to perform: determine validity of a TA.

23-24. (canceled)

25. The UE according to claim 21, wherein the determination of the validity of the TA comprises:
in response to a determination that a change in reference signal received power (RSRP) of a serving synchronization signal block (SSB) exceeds a first threshold, determining that the TA is invalid; and
in response to a determination that the change in the RSRP of the serving SSB does not exceed the first threshold, determining that the TA is valid.
